(19) United States
(12) Patent Application Publication
(10) Pub. No.: US 2019/0173779 A1
(43) Pub. Date: Jun. 6, 2019

(54) METHOD, SOFTWARE AGENT, NETWORKED DEVICE AND SDN CONTROLLER FOR SOFTWARE DEFINED NETWORKING A CYBER PHYSICAL NETWORK OF DIFFERENT TECHNICAL DOMAINS, IN PARTICULAR AN INDUSTRY AUTOMATION NETWORK

(71) Applicant: SIEMENS AKTIENGESELLSCHAFT, München (DE)

(72) Inventors: Axel Gruner, Nürnberg (DE); Amine Mohamed Houyou, Jersey City, NJ (US); Hans-Peter Huth, München (DE); Ermin Sakic, München (DE)

(21) Appl. No.: 16/324,355

(22) PCT Filed: Aug. 8, 2016
(86) PCT No.: PCT/EP2016/068881

§ 371 Date: Feb. 8, 2019

(51) Int. Cl. H04L 12/721; H04L 12/715; H04L 12/741; H04L 29/12; G06F 9/455

(52) U.S. Cl. CPC H04L 45/38; H04L 45/64; H04L 45/745; G06F 2009/45595; H04L 61/2015; G06F 9/45558; H04L 61/1511

(57) ABSTRACT

In order to extend the “Software Defined Networking” of the cyber-physical respectively the industry automation network such that the quality of networking is improved up to industrial grade and which resolves the bunch of problems discussed in the introductory part of the application, it is proposed to merge the usage control of Operating System resources by App's and/or Virtual Machines running on/hosted by a Networked Device including an Operating System in a cyber-physical Network with the controlling a modified SDN-System extending a conventional SDN-System to an “End-to-End”-Communication within the cyber-physical Network provides on a per-application-basis and to control all this from a SDN-Controller being adapted to these circumstances and requirements.

### CROSS-REFERENCE TO RELATED APPLICATIONS

This application claims priority to PCT Application No. PCT/EP2016/068881, having a filing date of Aug. 8, 2016, the entire contents both of which are hereby incorporated by reference.

### FIELD OF TECHNOLOGY

The following refers to a method for Software Defined Networking a cyber-physical Network of different technical domains according to the preamble of claim 1, a Software Agent for Software Defined Networking a cyber-physical Network of different technical domains according to the preamble of claim 9, a Networked Device for Software Defined Networking a cyber-physical Network of different technical domains according to the preamble of claim 17, and a SDN-Controller for Software Defined Networking a cyber-physical network of different technical domains according to the preamble of claim 24.

### BACKGROUND

In general and according to the publication “Software-Defined Networking Guide”; World Wide Technology, Inc.; 2014; pages 1 to 20 “Software Defined Networking (SDN)” being promoted by the Open Networking Foundation (ONF) has two characteristics—(i) a Control Plane is separated from a Data Plane implemented on a device and (ii) a single Control Plane manages multiple network devices.

Saying this SDN focuses essentially on SDN-Controllers using a Communication Protocol, such as OpenFlow®, as their “Southbound Interface” to the network devices.

The SDN-Controller is a software program running on at least one server that configure and control a number of network devices. By the expression “Southbound” it is noted an establishment of a communication channel between the SDN-Controller and the network device. In addition to the “Southbound Interface” the SDN-Controller comprises also a “Northbound Interface” which is a user and programmatic interface to direct actions of the SDN-Controller towards request services of the underlying network.

The cited protocol is somehow a communication channel that uses a Transmission Control Protocol (TCP) between the network device, such as a switch, router or gateway, and the SDN-Controller to control a forwarding path of the network device from the SDN-Controller. This is achieved and implemented by prescribing numerous matches on headers of data packet and with a list of actions. The actions specify whether the data packet is to be modified, flooded, dropped and output to one or more ports by using flow tables. The flow tables can be used proactively, before the data packets arrive at the network device or reactively, after the data packets have been received by the network device. In the reactive mode the data packets are copied and sent to the SDN-Controller for further analysis and the SDN-Controller sends a flow element to the network device to process the data packet. The SDN-Controllers may be programmed to use a combination of reactive and proactive processing. For this processing the network device includes an agent, which is generally a software program running on the network device to terminate the communications channel from SDN-Controller or an “Application Programming Interface (API)” running in software on a server. In turn, the agent is communicating with an Operating System running on a networked device, called sometimes as a network element.

SDN-specific Communication Protocols, such as OpenFlow®, focus on providing measures to configure forwarding paths and basic flow-based packet matching and filtering. In addition to forwarding configurations, OpenFlow® supports basic network QoS (Quality of Service), e.g. generic traffic prioritization through mechanisms such as “Differentiated Services Code Point (DSCP; DiffServ)”-marking, traffic metering and fast rerouting.

The OpenFlow®-Protocol is not only the lonely entity dealing with the SDN-principles. The goal of SDN is to enable a higher degree of control over network devices. This can be achieved by OpenFlow®, but it is not as already said the only tool to achieve or to accomplish this goal.

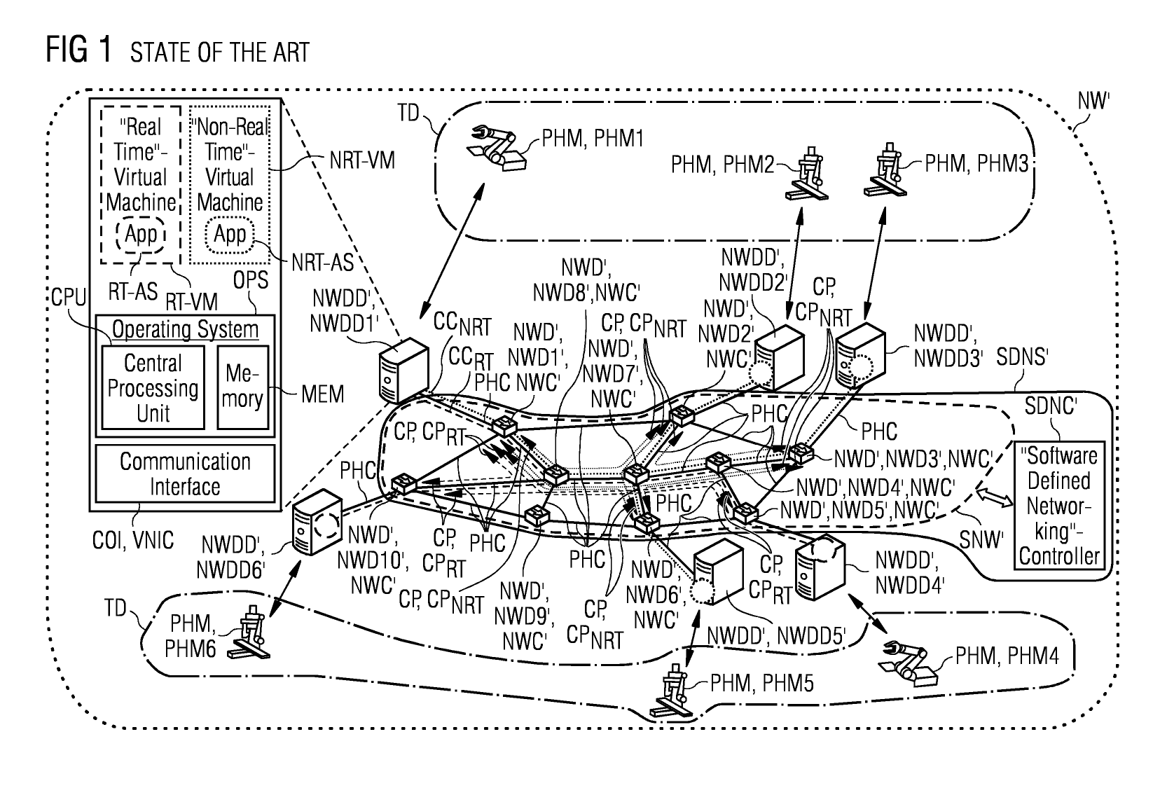

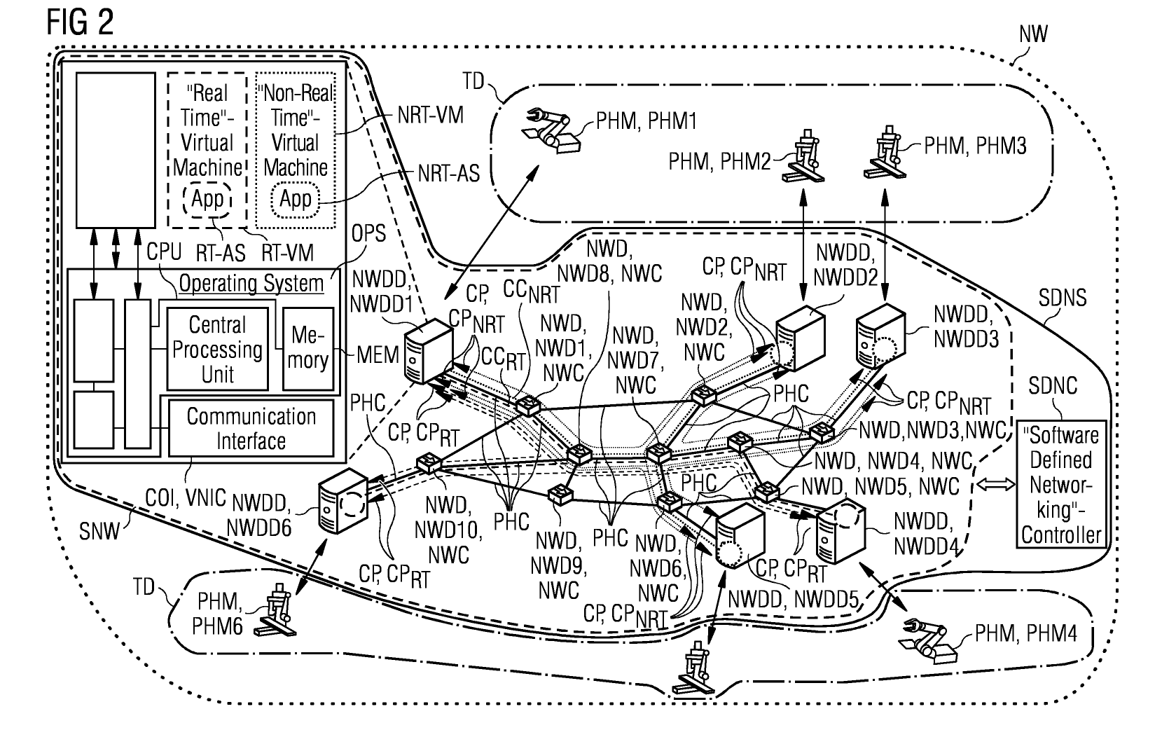

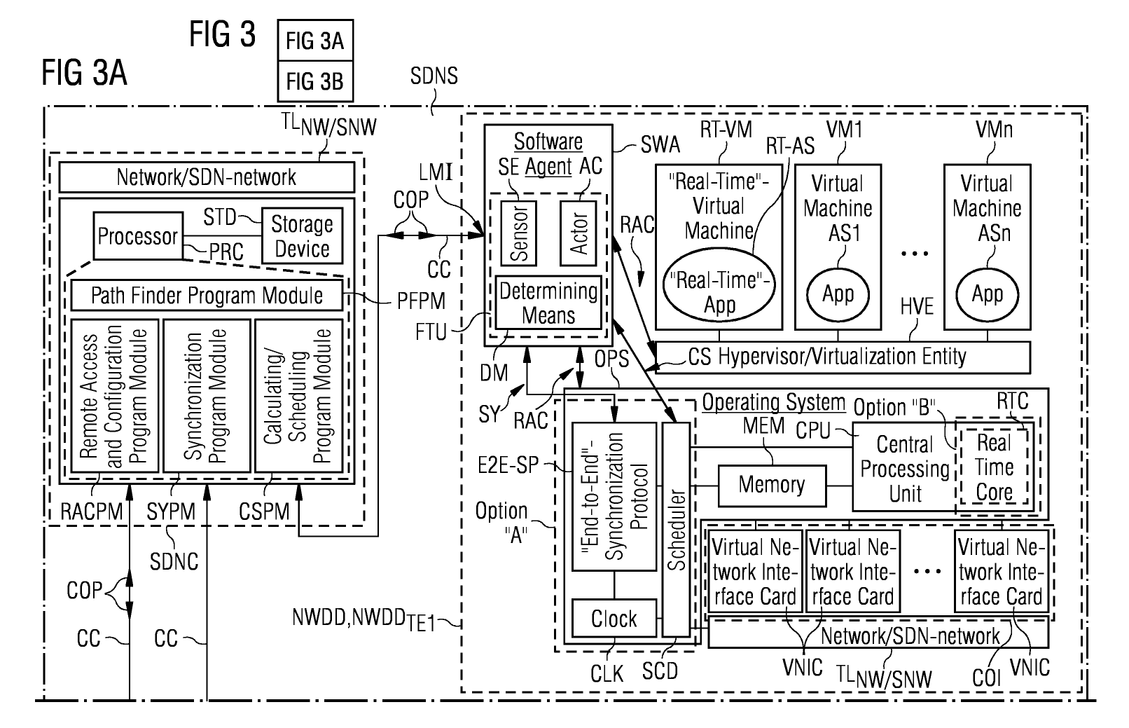

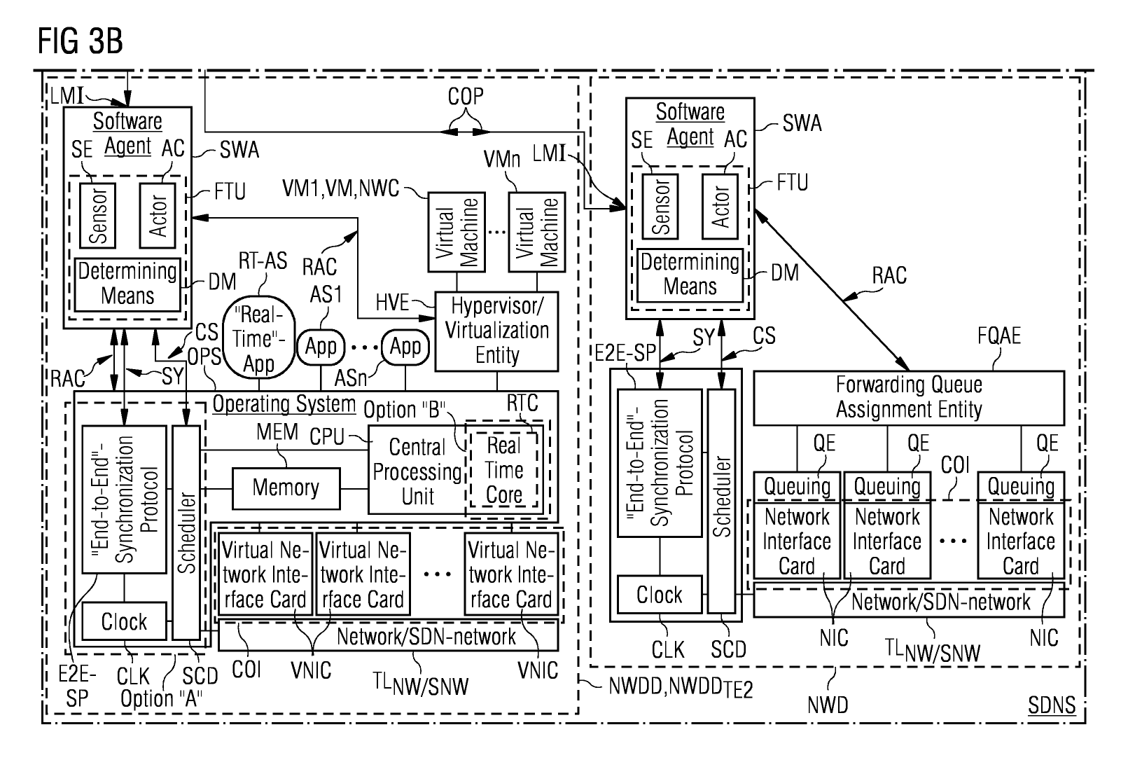

FIG. 1 shows a typical conventional (state-of-the-art) SDN-scenario in the environment of industry automation. This is only one example of numerous other technical domains, like medical, power generation and power distribution technology, the Software Defined Networking of a cyber-physical Network can be applied. This statement can be made also with regard to the present embodiments of the invention being described later on in connection with the FIGS. 2 and 3 which is related by way of example to an industry automation network.

The cited FIG. 1 depicts a cyber-physical Network NW′ of a technical domain TD, which is represented by Physical Machines PHM used in the industry automation environment. In the depicted cyber-physical Network NW′ there are six Physical Machines PHM1 . . . PHM6. To each of these Physical Machines PHM1 . . . PHM6 is assigned each a device NWDD′, which is responsible for the control of the assigned Physical Machine PHM such that each Physical Machine PHM1 . . . PHM6 is involved in the industrial automation process. For this reason there are also six devices NWDD1′ . . . NWDD6′ in the cyber-physical Network NW′. It should be noted that the number of the cited devices could be smaller as the number of Physical Machines. This however means leaving the number of Physical Machines unchanged that it is also possible that one device controls more than one Physical Machine.

According to the depicted cyber-physical Network NW′ the devices NWDD1′ . . . NWDD6′ and the Physical Machines PHM1 . . . PHM6 are outside of a subnetwork SNW′ the “Software Defined Networking (SDN)” is applied. This sub-network SNW′ referred to as a SDN-network is shown in the FIG. 1 by a dotted ellipse. The SDN-network SNW′ for implementing the “Software Defined Networking (SDN)” is controlled according to the preliminary remarks concerning the “Software Defined Networking (SDN)” by at least one SDN-Controller SDNC′. This is shown symbolically by the double line-double arrow between the SDN-Controller SDNC′ and the SDN-network SNW′ Both the SDN-network SNW′ and the SDN-Controller SDNC′ are designed as a SDN-System SDNS′.

Within the SDN-network SNW in the context of “Software Defined Networking (SDN)” and again following the preliminary remarks on SDN there are a number of Network Devices NWD′, which with respect to the SDN-implementation are connected to each other by physical channels PHC. According to the illustration in the FIG. 1 the SDN-network SNW′ includes ten Network Devices NDW1′ . . . NWD10′, which contrary to the six devices NWDD1′ . . . NWDD6′ are all inside the SDN-network SNW′ and thus are influenced regarding the SDN-aspects presented above by the SDN-Controller SDNC′.

With regard to the cyber-physical Network NW′ the six devices NWDD1′ . . . NWDD6′ are connected now again via physical channels PHC with the subnetwork or SDN-network SNW′. These connections in the present case are limited to some of the ten Network Devices NWD1′ . . . NWD10′.

Before saying which device goes with which Network Device, the six devices NWDD1′ . . . NWDD6′ with respect to the SDN-network SDW′ and following the expression Network Device are noted as Networked Devices, which referring to the “Software Defined Networking (SDN)” of the cyber-physical Network NW′ and in the view of the SDN-Controller SDNC′ are end-nodes, whereas consequently the Network Devices are intermediate nodes.

So a first Networked Device NWDD1′ is connected via the physical channel PHC with a first Network Device NWD1′, a second Networked Device NWDD2′ is connected via the physical channel PHC with a second Network Device NWD2′, a third Networked Device NWDD3′ is connected via the physical channel PHC with a third Network Device NWD3′, a fourth Networked Device NWDD4′ is connected via the physical channel PHC with a fifth Network Device NWD5′, a fifth Networked Device NWDD5′ is connected via the physical channel PHC with a sixth Network Device NWD6′ and a sixth Networked Device NWDD6′ is connected via the physical channel PHC with a tenth Network Device NWD10′.

Embedded in the SDN-network SNW′ on each of the six Networked Devices NWDD1′ . . . NWDD6′ could run in principle—although it is depicted only with reference to the first Networked Device NWDD1′—at least one “Real Time”-Virtual Machine RT-VM with at least one “Real Time-Application Software (App)” RT-AS and at least one “Non Real Time”-Virtual Machine NRT-VM with at least one “Non Real Time-Application Software (App)” NRT-AS. However, the App running on the Virtual Machine and thus indirectly on the Networked Device could also run directly on the Networked Device. This is the case for instance for the second Networked Device NWDD2′ to the sixth Networked Device NWDD6′. So on the second Networked Device NWDD2′, the third Networked Device NWDD3′ and the fifth Networked Device NWDD5′ is running directly each at least one “Non Real Time-Application Software (App)” NRT-AS, whereas on the fourth Networked Device NWDD4′ and the sixth Networked Device NWDD6′ is running directly each at least one “Real Time-Application Software (App)” RT-AS.

For hosting the Virtual Machine RT-VM, NRT-VM respectively the App RT-AS, NRT-AS and interfacing the communication to the SDN-network SNW′ via the physical channel PHC each Networked Device NWDD1′ . . . NWDD6′—although it is depicted again only with reference to the first Networked Device NWDD1′—includes an Operating System OPS with its system resources, such as a Central Processing Unit CPU and a Memory MEM, and a Communication Interface COI, which is designed exemplarily as a Virtual Network Interface Card VNIC.

Depending on which kind of process, a “Real Time”- and/or a “Non Real Time”-process should be handled, distinct control channels CC_{RT}, CC_{NRT} are set up on the physical channel PHC. So there are established between the first Networked Device NWDD1′ and the first Network Device NWD1′ a “Real Time”-control channel CC_{RT} (dashed line in the FIG. 1) and a “Non Real Time”-control channel CC_{NRT} (dotted line in the FIG. 1).

Moreover between the second Networked Device NWDD2′ and the second Network Device NWD2′, between the third Networked Device NWDD3′ and the third Network Device NWD3′ as well as between the fifth Networked Device NWDD5′ and the sixth Network Device NWD6′, because of each hosting the “Non Real Time-Application Software (App)” NRT-AS, the “Non Real Time”-control channel CC_{NRT} (dotted line in the FIG. 1) is set up, while between the fourth Networked Device NWDD4′ and the fifth Network Device NWD5′ as well as between the sixth Networked Device NWDD6′ and the tenth Network Device NWD10′, because of each hosting the “Real Time-Application Software (App)” RT-AS, the “Real Time”-control channel CC_{RT} (dashed line in the FIG. 1) is established.

When the Network Devices in general and the first Network Device NWD1′, the second Network Device NWD2′, the third Network Device NWD3′, the fifth Network Device NWD5′, the sixth Network Device NWD6′ and the tenth Network Device NWD10′ in particular are each nodes of the SDN-network SNW′, the other nodes within the SDN-network SNW′ are connected also by the physical channels PHC and the origin and destination of a connection within the SDN-network SNW′ is a path, then the origin and destination of a connection within the SDN-network with regard to the control channels CC_{RT}, CC_{NRT} are control paths CP. According to the depicture in the FIG. 1 the control paths referring to the “Real Time”-control channel CC_{RT} are control paths CP_{RT} and the control paths referring to the “Non Real Time”-control channel CCN_{RT} are control paths CPN_{RT}.

Before going on with aspects and the purpose of the “Software Defined Networking (SDN)” it should be noted, because the FIG. 1 does not show it, that the Network Device NWD′ within the SDN-network SNW′ in a modified realization/implementation could be realized as a Virtual Machine in the Networked Device NWDD′. For this reason it is more precisely to speak about a Network Component NWC, which means that the defined Network Component NWC is either the Network Device or a virtual Network Device.

With respect to the purpose of the “Software Defined Networking (SDN)”-generally speaking and already implying above—the handling of data packets and routing or controlling decisions within the Network NW are separated such that the data packet handling, in particular data packet forwarding by the intermediate node and data packet transmitting by the end node, is done via data paths and the handling of routing or controlling decisions is done via the control paths CP involving at least one of the Network Components NWC′ and remotely controlled by the SDN-Controller SDNC′ using a Communication Protocol such as the OpenFlow®-Protocol according to which at least one of PUSH/PULL-based commands and PUSH/PULL-based messages are sent and received.

Since the Networked Devices NWDD1′ . . . NWDD6′ hosting a number of Virtual Machines and/or App's of the depicted scenario in the FIG. 1 are not part of the SDN-System SDNS and hence no devices which are controlled in the sense of SDN by the SDN-Controller SDNC′ it can't be ensured against the background of an industry automation network with requirements, such as industrial grade, being an appropriate candidate for Software Defined Networking a cyber-physical Network as described regarding the FIG. 1 that at least the afore-described “Real Time”-process is supported by the involved Network Devices, e.g. the Network device NWD1 in the FIG. 1, respectively where applicable the involved Network Components. Due to the described SDN-System SDNS' in the FIG. 1 the “Real Time”-process looses an “End-to-End”-deterministic “Real Time”-behavior by using the conventional SDN-Controller SDNC′ according to the FIG. 1. For this reason the intermediate nodes respectively the Network Components NWC′ or Network Devices NWD′ within the SDN-network SNW′, which control for instance besides the cited flow tables inter alia traffic classes etc., won't support the “Real Time”-processes including the “Real Time”-control channels CC_{RT}.

So far most SDN-solutions are focused on controlling the routing/switching infrastructure which is remotely configurable by the SDN-Controller. The Networked Devices, which include each as described above the Operating System with its system resources, respectively network end devices or end-nodes where Virtual Machines, App's or users (or tenant) are hosted are not part of the Network Devices or Network Components as controlled entities controlled by the SDN-Controller.

However many state-of-the-art Operating Systems offer several options to control resource usage by Virtual Machines and/or App's. For example Virtual Machines and/or App's can be prioritized to receive better “Real-Time”-experience, the Memory space can be limited or the access to certain Operating System resources (e.g. graphic card, network) can be granted or denied. There are various interfaces to configure those aspects, depending also on the Operating System. As a result rules, typically Operating System-wide and per-user, exist.

Industrial grade SDN-networks of the cyber-physical Network have to deliver separate configurable network paths dimensioned and selected along multiple criteria for each tenant. This does not only require a path definition in the networking intermediate devices but also provide guarantees which span “End-to-End” from servers to IO-devices and IO-controllers.

A modified SDN-Controller for this purpose has to deliver industrial grade communication services “End-to-End” by guaranteeing network resources allocated “End-to-End” thereby involving the network end devices or end-nodes. The heterogeneity of the computing platforms and their different used run-time have to be add to the variety of control methods that an SDN controller has to configure. The assumption made in previous SDN-approaches that it is possible to define a single interface to a new standardized type of platform does not hold in the case of end nodes.

A new SDN-approach is also used to enforce limitations or control resource usage, e.g. a data stream cannot go beyond a certain bandwidth unless granted by the SDN-system comprising the SDN-Controller and the SDN-network.

The type of SDN-enforcement in end-nodes could also include methods that go beyond the configuration or enforcement of SLA for a network interface (e.g. queues, network shapers etc.). There are also other possibilities to enforce resource separation for different applications within the same host by controlling the resource allocated to a virtual machine (sandboxing), virtual network device (e.g. switch, network interfaces, etc). All the above methods are not covered by existing SDN-specific Communication Protocols such as OpenFlow®.

### SUMMARY

An aspect relates to a Method, Software Agent, Networked Device and SDN-Controller for Software Defined Networking a cyber-physical network of different technical domains, in particular an industry automation network, which extends the “Software Defined Networking” of the cyber-physical respectively the industry automation network such that the quality of networking is improved up to industrial grade and which resolves the bunch of problems discussed above.

The underlying idea of the embodiments of the invention to merge the usage control of Operating System resources—e.g. the prioritization to receive better “Real-Time”-experience, the limitation of Memory space, the grant or denial of access to certain Operating System resources, etc.—by App's and/or Virtual Machines running on/hosted by a Networked Device including an Operating System in a cyber-physical Network with the controlling a modified SDN-System extending a conventional SDN-System to an “End-to-End”-Communication within the cyber-physical Network provides on a per-application-basis and to control all this from a SDN-Controller being adapted to these circumstances and requirements. Thus against the background of the embodiments of the invention it can be spoken of an adapted SDN-Controller.

This merging is implemented by a Software Agent as additional logic and configuration elements assigned to the Operating System in the Networked Device managing the properties of the Networked Device and the App's and/or Virtual Machines running on/hosted by the Networked Device, which allows the introduction of flexible data models and which in addition to all the features provided by a forwarding rules management protocol enables remote access management concerning the App's and/or Virtual Machines, containers instantiation, configuration of cyber-physical network-related appliances, etc.

The Software Agent is running in all Networked Devices and Network Devices respectively Network Components of the cyber-physical Network. The prerequisites on the cited Networked Devices being controllable by the adapted SDN-Controller over an “End-to-End”-Communication within the cyber-physical Network between the Networked Device and the adapted SDN-Controller is that they offer the possibility of being connected to the cyber-physical Network through the Communication Interface, in particular through the Network Interface Card (NIC), they have an Operating System which can support many of the networking stack protocols including some type of QoS-control, and include appropriate means to control resource usage of the App's and/or Virtual Machines.

The Software Agent encapsulates the methods to access any of these implementations within each Networked Device/Network Device respectively Network Component into a modular function list. By allowing the introduction of a specified flexible data model, the Software Agent will expose a management interface for remote modification of any configurable SDN-System parameters. The Software Agent's integrity can be ensured by means of process isolation mechanisms.

The Software Agent provides a single interface per Networked Device/Network Device respectively Network Component that allows a control channel to exist between the Networked Device/Network Device respectively Network Component and the adapted SDN-Controller.

The received commands and messages sent by the Software Agent to and from the adapted SDN-Controller are generic commands, which are technology independent and implementation independent. The modular function model of the Software Agent implementation has two roles

a) Offering and allowing remote control of the different Networked Device/Network Device respectively Network Component capabilities to the SDN-Controller through the generic and implementation independent control channel and Communication Protocol;
b) Encapsulating the Software Agent's modular functions and their different technological implementations by allowing bi-directional translation between the generic SDN-Controller messages and the internal implementation of the technology.

The necessity for such a Software Agent is, because

(i) Conventional SDN-specific configuration protocols, such as the OpenFlow®, focus on providing measures to configure forwarding paths and basic flow-based packet matching and filtering. In addition to forwarding configurations, the OpenFlow® supports the basic network QoS (Quality of Service), e.g. generic traffic prioritization through mechanisms such as the “Differentiated Services Code Point (DSCP; DiffServ)”-marking, the traffic metering and the fast rerouting.
(ii) the OpenFlow®-standard does not define the elements to configure and monitor other SDN-System aspects of the Network Components respectively the Network Devices, such as virtual interface configurations, forwarding table sizes, administrative access policies and similar. The use cases of managing individual devices and system resources which go beyond the configuration of basic forwarding rules and associated QoS are out of scope in the OpenFlow®.

The tasks of the Software Agent according to the embodiments of the invention are:

1) The extent of control carried out on the Networked Device hosting a Virtual Machine-logic and/or App-logic.
2) The resource management of any type that can be assigned to the Virtual Machine and/or App both network-related and also computational or with reference to the Memory.
3) The consideration in the industry automation network environment of all automation application requirements in terms of resource isolation and resource sharing methods to include all possible controllable resources on an “App/Virtual Machine-hosting-industrial-Networked Device”. The focus is also on industrial App/Virtual Machine requirements and the way they could run on multi-purpose computing Networked Devices, which host other non-industrial App's/Virtual Machines at the same time.

Such a complex Networked Device is a more advanced computing platform than a conventional legacy Programmable Logic Controller (PLC) which is rather offering features than it is allocating “Real-Time”-Application exclusive access and guarantees from computing power to network access. The type of Operating System that can offer such guarantee is not in focus here, even if a Linux OS with some “Real-Time”-extensions has the possibility to offer different levels of virtualization and some “Real-Time”-Network Access today. The role of the Software Agent is also to make sure that the guarantee is unbroken (from App/Virtual Machine “Real-Time”-access to the computing resources to the way this App/Virtual Machine-related traffic is treated by the SDN-network stack).

The Software Agent also offers the possibility to upload “network-related App's” that also run as generic functions or simply act in the Networked Device as an application process such as “Firewall function”, DNS Server function, etc.

The industrial-grade services controlled by the adapted SDN-Controller include:

### SDN-Network Related Issues:

1. Identity and address mapping and configuration of flows [1] and slices [2]
2. and the way they are recognized in the SDN-network.
3. Distributing and configuring forwarding entry to next hops in each Networked Device/Network Device respectively Network Component.
4. SDN-network resource allocation in terms of queue length or QoS marking, or traffic shaping rules for a given flow, tenant, slice.
5. Monitoring the Networked Device/Network Device respectively Network Component and constantly optimizing the resource sharing and allocations based on actual utilization.
6. Ensuring and validating runtime correctness of configured forwarding and resource allocations.

SDN-Network Supporting Functions at the Networked Devices:
7. Starting a synchronization protocol instances at those Networked Devices that are part of a single synchronization domain (i.e. use shared clock information, or coordinate a time division multiplexing access to a synchronized communication channel, e.g. Profinet IRT, TSN's Time-Aware Scheduler (TAS)).
8. Starting local instances of networking functions such as DNS, DHCP, a network access control registry or firewall for the supporting a specific slice members.
9. Configuring networking functions such as DNS, DHCP, a network access control registry or firewall to reflect the Networked Devices requirements on “End-to-End”-connectivity.

Acting on Real and Virtual Computing Resources:
10. Allocating and starting a slice of the Operating system with its system resources [e.g. Memory, “Central Processing Unit (CPU)” ] for a given Virtual Machine or to a given App.
11. Starting a Virtual Network and Switch in private cloud or server infrastructure.

The Software Agent also fulfills the following functions:
A. Manages the bootstrapping of the managed Networked Device/Network Device respectively Network Component as part of the SDN-network. This includes the boot sequence and discovery process of direct neighbors and the way to reach the nearest SDN-controller. The Software Agent is also seen as secured policy enforcer capable of blocking any messages sent to neighboring Networked Device/Network Device respectively Network Component. This could be used to isolate the Networked Device/Network Device respectively Network Component until it is authenticated, or explicitly provided access to the SDN-network or remotely to the adapted SDN-Controller. The Software Agent can then setup the authentication channels to the correct instances.
A. The Software Agent of an already “operational” Networked Device/Network Device respectively Network Component can act as a proxy for “newly connected” neighboring agents during their bootstrapping phases limiting the way the new node can further connect in the SDN-network. For instance the new neighbor could reach the adapted SDN-Controller after the already connected agent allows further connectivity to a configuration slice. Only then other services are reachable such as IP address allocation through a DHCP server or even ID allocation (e.g. DSN names). Such a configuration slice could use a similar method to the spanning tree where the root is the adapted SDN-Controller. A new device starts first its “networking agent”; afterwards, the direct neighboring agents, which are already operational, are discovered. One of the neighboring agents then takes over the proxy role.
B. The registration process also includes representing the nodes capabilities, type, or offered services in a generic node model that the adapted SDN-Controller can use in addressing the node offered services such as the ability to configure jitter or delay guarantees within an announced range, virtual interfaces instantiation, applications sandboxing etc.
C. The encapsulation of locally available technologies and offered resources into a list of services that the Software Agent can provide and which can be controlled by an industrial SDN-Controller. The type of resources offered goes beyond just the possibility to deliver network QoS but also include computing resources and the ability to guarantee a certain behavior such as “Real-Time Operating System”-behavior or ability to receive a guaranteed share of CPU-power and memory. The service representation of the offered resource allows describing both the resource and the way it can be offered (e.g. fully guaranteed isolated resources such as a “Real-Time”−“CPU Core”, statistic resource share, or a rough estimate of the way the resource can be accessed and scheduled). The Software Agent announces such resources and the possibility to guarantee them or isolate them in a similar way to the way network features and resources are presented or provided. The Software Agent uses a generic model to describe such capabilities, which can be then presented to the adapted SDN-Controller.
D. The adapted SDN-Controller can then receive requests by the Virtual Machines and/or App's and decides to orchestrate the system resources available on the Virtual Machines and/or App's-hosting Networked Device. The adapted SDN-Controller accesses the resource-managing service through the Software Agent and triggers in a generic manner the resource enforcement by defining the goal resource rather than the method to enforce it. The Software Agent contains the details of how to allocate the resource internally, such as knowing that a end-host can support containers, or full virtual machines that are can be allocated a type of CPU-power or CPU-core and a given share of memory with a certain type of guarantee. One encapsulation and enforcement method is to start the Virtual Machines and/or App's wishing to access a slice in a virtualization (e.g. container or full virtual Operating System) and binding the slice interface established in step D above) to a virtual interface in that virtualization. Another method is to use user rights and access control lists of the Operating System mapped to an Operating System User respectively an Operating System User Group and run the Virtual Machine and/or App under those users or groups.
E. On the pages above referring to the embodiments of the invention it is explained the way to interface to and extend the conventional Communication Protocol OpenFlow® and “Time Sensitive Networking (TSN)”-capable network nodes to provide a broader set of features not handled in originating standardization efforts. It is explained further how to provide industrial-grade services by defining methods to access the real-time capable, e.g. industrial, communication and application functions provided in underlying implementations.

By using, deploying, implementing the Software Agent the following benefits are associated:
1. The definition of cyber-physical, e.g. industrial, networking functions and services offered by any single Networked Device are seen as a modular, extensible list of offering and controllable functions, which are all remotely controllable or accessible by the adapted SDN-Controller. Such modular capabilities of Networked Device go beyond only networking features and allow also managing other resources that are relevant to a cyber-physical, e.g. industrial, Virtual Machine and/or App being hosted by the Networked Device such as allocating a “Real-Time”−“CPU Core”, allocating and guaranteeing a CPU/Memory-share (cf. dependent claims 2 to 5, 10 to 13 and 18 to 21).
2. There is one Software Agent on the controlled Networked Device/Network Device respectively Network Component, independent of the type of functions hosted in the Networked Device/Network Device respectively Network Component. The Software Agent is capable of creating a control channel between the Networked Device/Network Device respectively Network Component and the adapted SDN-Controller.
3. The control channel to each Networked Device/Network Device respectively Network Component requires a technology independent implementation or language specifying how to interact with all types of controllable functions or offerings by any type of Networked Device/Network Device respectively Network Component. The interactions between the adapted SDN-Controller and the Networked Device/Network Device respectively Network Component include any pattern of messages required by the functions such as remotely pushed messages from the adapted SDN-Controller to the Networked Device/Network Device respectively Network Component, broadcasts from the Software Agent to its direct neighborhood, message updates or event-triggered messaged pushed from the Software Agent to the adapted SDN-Controller, or pulled information from the Networked Device/Network Device respectively Network Component to the adapted SDN-Controller. Each function requires a specific pattern of message interaction and this type of messages follow a generic language.
4. The Software Agent coordinates the functions where the translation occurs between the generic controller commands and the internal technology-dependent function.
5. The Software Agent run on devices can also act as coordinator of booting a single Networked Device/Network Device respectively Network Component and internal functions which require interaction with a backend infrastructure.
6. The Software Agent run on an already connected Networked Device/Network Device respectively Network Component could act as a proxy for a new Networked Device/Network Device respectively Network Component to allow the new Networked Device/Network Device respectively Network Component find its way to the adapted SDN-Controller or to implement authentication mechanisms of non-trusted devices.
7. The modularity of the functions could allow extensibility in a “Virtual Machine and/or App” like manner, where the Software Agent can receive a piece of code to run as a new “platform-independent”-function.
8. In the case of a larger server, multiple instances of the Software Agent, each, controlling just one part of virtual resources and/or disjoint technologies, connecting flexibly to different SDN-Controllers.

### BRIEF DESCRIPTION

Moreover advantageous further developments of the embodiments of the invention arise out of the following description of a preferred embodiment of the invention according to the FIGS. 2 and 3. They show:

FIG. 2 based on the FIG. 1, which refers the state-of-the-art of a typical conventional SDN-System in the environment of industry automation, a modified “Software Defined Networking (SDN)”-System based on an extended “End-to-End”-Communication;

FIG. 3A based on a simplified diagram the cooperation of system components of the modified “Software Defined Networking (SDN)”-System according to the FIG. 2 on Network-/Transport-Layer-Level.

FIG. 3B based on a simplified diagram the cooperation of system components of the modified “Software Defined Networking (SDN)”-System according to the FIG. 2 on Network-/Transport-Layer-Level.

### DETAILED DESCRIPTION

FIG. 2 shows—based on the FIG. 1, which refers according to the state-of-the-art to a typical conventional SDN-scenario in the environment of industry automation involving a conventional SDN-System—a modified “Software Defined Networking (SDN)”-scenario with respect to a modified cyber-physical Network NW of the same technical domain TD as in the FIG. 1 thereby involving a modified “Software Defined Networking (SDN)”-System SDNS based on an extended “End-to-End”-Communication.

The cited FIG. 2 depicts the cyber-physical Network NW of the technical domain TD, which is represented by the Physical Machines PHM used in the industry automation environment. In the depicted cyber-physical Network NW there are again the six Physical Machines PHM1 . . . PHM6. To each of these Physical Machines PHM1 . . . PHM6 is assigned each a modified device NWDD, which again is responsible for the control of the assigned Physical Machine PHM such that each Physical Machine PHM1 . . . PHM6 is involved in the industrial automation process. For this reason there are also six modified devices NWDD1 . . . NWDD6 in the cyber-physical Network NW. It should be noted that again the number of the cited devices could be smaller as the number of Physical Machines. This however means leaving the number of Physical Machines unchanged that it is also possible that one device controls more than one Physical Machine.

According to the depicted modified cyber-physical Network NW the modified devices NWDD1 . . . NWDD6 and the Physical Machines PHM1 . . . PHM6 are now contrary to the FIG. 1 inside of a modified sub-network SNW the “Software Defined Networking (SDN)” is applied. This sub-network SNW referred to as a SDN-network is shown in the FIG. 2 by a dotted curve. The SDN-network SNW for implementing the “Software Defined Networking (SDN)” is controlled according to the preliminary remarks concerning the “Software Defined Networking (SDN)” by at least one modified SDN-Controller SDNC. This is shown symbolically again by the double line-double arrow between the SDN-Controller SDNC and the SDN-network SNW. Both the SDN-network SNW and the SDN-Controller SDNC form the modified SDN-System SDNS.

Within the SDN-network SNW in the context of “Software Defined Networking (SDN)” and again following the preliminary remarks on SDN there are again and in addition a number of modified Network Devices NWD, which with respect to the SDN-implementation are connected to each other by physical channels PHC. According to the illustration in the FIG. 2 the SDN-network SNW includes ten Network Devices NDW1 . . . NWD10 and the six devices NWDD1 . . . NWDD6, which are all inside the SDN-network SNW and thus are influenced regarding the SDN-aspects presented above by the modified SDN-Controller SDNC. In this manner the extended “End-to-End”-Communication is realized, because the modified SDN-Controller SDNC can now communicate regarding the SDN-aspects with the six modified devices NWDD1 . . . NWDD6.

Therefore the six devices NWDD1 . . . NWDD6 are connected within the subnetwork or SDN-network SNW again via physical channels PHC with some of the ten Network Devices NWD1 . . . NWD10. The six devices NWDD1 . . . NWDD6 with respect to the SDN-network SDN and following the expression Network Device are noted again as Networked Devices, which referring to the “Software Defined Networking (SDN)” of the cyber-physical Network NW and in the view of the SDN-Controller SDNC are end-nodes, whereas consequently the Network Devices are intermediate nodes.

So again a first modified Networked Device NWDD1 is connected via the physical channel PHC with a first modified Network Device NWD1, a second modified Networked Device NWDD2 is connected via the physical channel PHC with a second modified Network Device NWD2, a third modified Networked Device NWDD3 is connected via the physical channel PHC with a third modified Network Device NWD3, a fourth modified Networked Device NWDD4 is connected via the physical channel PHC with a fifth modified Network Device NWD5, a fifth modified Networked Device NWDD5 is connected via the physical channel PHC with a sixth modified Network Device NWD6 and a sixth modified Networked Device NWDD6 is connected via the physical channel PHC with a tenth modified Network Device NWD10.

Embedded in the modified SDN-network SNW on each of the six modified Networked Devices NWDD1 . . . NWDD6 could run again in principle—although it is depicted only with reference to the first Networked Device NWDD1—at least one of the “Real Time”-Virtual Machine RT-VM with at least one of the “Real Time-Application Software (App)” RT-AS and at least one of the “Non Real Time”-Virtual Machine NRT-VM with at least one of the “Non Real Time-Application Software (App)” NRT-AS. However, the App running on the Virtual Machine and thus indirectly on the Networked Device again could also run directly on the Networked Device. This for instance is the case for the second modified Networked Device NWDD2 to the sixth modified Networked Device NWDD6. So on the second modified Networked Device NWDD2, the third modified Networked Device NWDD3 and the fifth modified Networked Device NWDD5 is running directly each at least one of the “Non Real Time-Application Software (App)” NRT-AS, whereas on the fourth modified Networked Device NWDD4 and the sixth modified Networked Device NWDD6 is running directly each at least one of the “Real Time-Application Software (App)” RT-AS.

For hosting the Virtual Machine RT-VM, NRT-VM respectively the App RT-AS, NRT-AS and interfacing the communication to the SDN-network SNW via the physical channel PHC each modified Networked Device NWDD1 . . . NWDD6—although it is depicted again only with reference to the first Networked Device NWDD1—includes again the Operating System OPS with its system resources, such as the Central Processing Unit CPU and the Memory MEM, and the Communication Interface COI, which is designed again exemplarily as the Virtual Network Interface Card VNIC.

Moreover each modified Networked Device NWDD1 . . . NWDD6 and its Operating system OPS comprises contrary to the Networked Device NWDD1′ . . . NWDD6′ in the FIG. 1 further entities/modules, which being implied in the present FIG. 2 only will be designated and described explicitly in connection with FIG. 3.

Again depending on which kind of process, the “Real Time”- and/or the “Non Real Time”-process should be handled, distinct control channels CC_{RT}, CC_{NRT} are set up on the physical channel PHC. So again between the first modified Networked Device NWDD1 and the first modified Network Device NWD1 there are established the “Real Time”-control channel CC_{RT} (dashed line in the FIG. 2) and the “Non Real Time”-control channel CC_{NRT} (dotted line in the FIG. 2). Moreover again between the second modified Networked Device NWDD2 and the second modified Network Device NWD2, between the third modified Networked Device NWDD3 and the third modified Network Device NWD3 as well as between the fifth modified Networked Device NWDD5 and the sixth modified Network Device NWD6, because of hosting each the “Non Real Time-Application Software (App)” NRT-AS, the “Non Real Time”-control channel CC_{NRT} (dotted line in the FIG. 1) is set up, while again between the fourth modified Networked Device NWDD4 and the fifth modified Network Device NWD5 as well as between the sixth modified Networked Device NWDD6 and the tenth modified Network Device NWD10, because of hosting each the “Real Time-Application Software (App)” RT-AS, the “Real Time”-control channel CC_{RT} (dashed line in the FIG. 1) is established.

When the Network Devices and the Networked Devices in general and the first Network Device NWD1, the second Network Device NWD2, the third Network Device NWD3, the fifth Network Device NWD5, the sixth Network Device NWD6 and the tenth Network Device NWD10 as well as the Networked Devices NWDD1 . . . NWDD6 in particular are each nodes of the modified SDN-network SNW, the other nodes within the SDN-network are connected also by the physical channels PHC and the origin and destination of a connection within the SDN-network SNW is again the path, then again the origin and destination of a connection within the modified SDN-network with regard to the control channels CC_{RT}, CC_{NRT} are the control paths CP. According to the depicture in the FIG. 2 the control paths referring to the “Real Time”-control channel CC_{RT} are the control paths CP_{RT} and the control paths referring to the “Non Real Time”-control channel CCN_{RT} are the control paths CPN_{RT}.

Again it should be noted, because the FIG. 2 does not show it, that the modified Network Device NWD within the modified SDN-network SNW in a further modified realization/implementation could be realized as a Virtual Machine in the modified Networked Device. For this reason it is more precisely to speak about a modified Network Component NWC, which means that the defined modified Network Component NWC is either the modified Network Device or a modified virtual Network Device.

Again with respect to the purpose of the “Software Defined Networking (SDN)”—generally speaking and already implying—the handling of data packets and routing or controlling decisions within the modified Network NW are separated such that the data packet handling, in particular data packet forwarding by the intermediate node and data packet transmitting by the end node, is done via data paths and the handling of routing or controlling decisions is done via the control paths CP involving at least one of the modified Network Components NWC and remotely controlled by the modified SDN-Controller SDNC using a modified Communication Protocol according to which at least one of PUSH/PULL-based commands and PUSH/PULL-based messages are sent and received.

Now since the modified Networked Devices NWDD1 . . . NWDD6 hosting a number of Virtual Machines and/or App's of the depicted scenario in the FIG. 2 are devices which are controlled in the sense of SDN by the modified SDN-Controller SDNC it can be ensured against the background of an industry automation network with requirements such as industrial grade being an appropriate candidate for Software Defined Networking a cyber-physical Network as describe regarding the FIG. 2 that at least the afore-described “Real Time”-process is supported by the involved modified Network Devices, e.g. the first modified Network device NWD1 in the FIG. 2, respectively where applicable the involved Network Components. Due to the described modified SDN-scenario in the FIG. 2 in connection with the following description of FIG. 3 the “Real Time”-process does not lose the “End-to-End”-deterministic “Real Time”-behavior by using additional entities in the modified Networked Devices NWDD1 . . . NWDD6 and the modified Network Devices NWD1 . . . NWD10 respectively the Network Components in connection with the modified SDN-Controller according to the FIG. 2.

FIG. 3 shows based on a simplified diagram the cooperation of system components of the modified “Software Defined Networking (SDN)”-System SDNS according to the FIG. 2 on Network-/Transport-Layer-Level.

The system components of the modified SDN-System include according to the depicture in the FIG. 3 the modified SDN-Controller SDNC, two modified Networked Devices NWDD with each a different technical emphasis, a modified Networked Device with a first technical emphasis NWDD_{TE1} and a modified Networked Device with a second technical emphasis NWDD_{TE2} and the modified Network Device NWD.

In a first step the single system components and its structural set-up in the order mentioned above and in a second step the cooperation of system components will be described, whereby all cited system components have for the communication into the Network NW/SDN-network SNW a common technical link TL_{NW/SNW}.

Besides this technical link, the modified SDN-Controller SDNC includes a Processor PRC, to which are assigned a Path Finder Program Module PFPM, a Calculating/Scheduling Program Module CSPM, a Synchronization Program Module SYPM and a Remote Access and Configuration Program Module RACPM and a non-transitory processor readable Storage Device STD having processor-readable program-instructions stored therein. The processor-readable program-instructions are executable by the Processor PRC to handle data packets and to route or control decisions within the Network NW by involving the Path Finder Program Module PFPM, the Calculating/Scheduling Program Module CSPM, the Synchronization Program Module SYPM and the Remote Access and Configuration Program Module RACPM.

Furthermore, the modified Networked Device with the first technical emphasis NWDD_{TE1}, which is preferably designed as a Computer, a Server, a Server farm, a Programmable Logic Controller (PLC), etc., includes besides the cited technical link the Operating System OPS with various system resources. These include inter alia the Central Processing Unit CPU, the Memory MEM connected with Central Processing Unit CPU, a Scheduler SCD assigned to the Memory MEM, the Central Processing Unit CPU and the technical link TL_{NW/SNW}, a “End-to-End”-Synchronization Protocol E2E-SP assigned to the Scheduler SCD and a clock CLK assigned to Scheduler SCD and the “End-to-End”-Synchronization Protocol E2E-SP.

Moreover the modified Networked Device with the first technical emphasis NWDD_{TE1} include

1) the Communication Interface COI, which comprises a number of the Virtual Network Interface Cards VNIC being oriented towards the number of Virtual Machines and/or App's the Networked Device with the first technical emphasis NWDD_{TE1} is hosting and which serves as linkage between the Operating system OPS and the technical link TL_{NW/SNW},
2) a Hypervisor/Virtualization Entity HVE, which is administrating the number of Virtual Machines hosted by the Networked Device with the first technical emphasis NWDD_{TE1} and which serves as linkage between the Operating System OPS and these Virtual Machines and finally
3) a Software Agent SWA, which as the central control entity particularly with regard to the “Software Defined Networking” in the modified “Software Defined Networking (SDN)”-System SDNS is assigned to the Scheduler SCD, the “End-to-End”-Synchronization Protocol E2E-SP, the Operating System OPS and the Hypervisor/Virtualization Entity HVE.

To 2): The number of Virtual Machines and whether at least one App is running the Virtual Machines hosted in total by the Networked Device with the first technical emphasis NWDD_{TE1} is in principle arbitrary. However, in the present case there are one “Real Time”-Virtual Machine RT-VM on which is running one “Real Time-Application Software (App)” RT-AS and “n” Virtual Machines VM1 . . . VMn on which are running “n” “Application's Software (App's)” AS1 . . . ASn. This means that the cited Application's Software (App's)” RT-AS, AS1 . . . ASn are running indirectly on the Networked Device with the first technical emphasis NWDD_{TE1}.

To 3): In his function as the central control entity particularly with regard to the “Software Defined Networking” in the modified “Software Defined Networking (SDN)”-System SDNS the Software Agent SWA includes

a) at least one Sensor SE perceiving an operating environment of the Software Agent SWA defined by the Networked Device NWDD within the Network respectively the SDN-network and regarding the SDN-purpose of the modified “Software Defined Networking (SDN)”-System SDNS,
b) at least one Actor AC interacting in that environment and
c) Determining Means DM for determining how the Software Agent SWA is going to interact with the environment.
These cited SWA-elements are designed such and forming a Functional Unit FTU referring to as an “agent function”.

The FIG. 3 illustrates a possible implementation of the Software Agent SWA in his function as the central control entity particularly with regard to the “Software Defined Networking” in the modified “Software Defined Networking (SDN)”-System SDNS. Several Virtual Machines and/or App's the Networked Device compete for the Network respectively the SDN-network and other system resources of the Networked Device. The Software Agent SWA on the Networked Device controls network access, in this example it may have created “virtual interfaces” which look like physical interfaces Virtual Machines and/or App's point of view. These are supported by Operating System. Furthermore, the Software Agent SWA has started a Virtual Switch or Virtual Bridge (not shown in the FIG. 3) on the Networked Device to connect the Virtual Network Interface Card VNIC to the physical interfaces. It then can attach traffic control rules to the interfaces to enforce the resource sharing for the Network respectively the SDN-network. Typical exemplary rules might be “limit outgoing traffic of one VNIC to 5 Mbps”, “prefer outgoing traffic from another VNIC in case of shortages” and more. Accordingly, the Software Agent SWA may set rules for the MEM- and CPU-usage in the Operating System by the Virtual Machines and/or App's and rules to permit access to the virtual interfaces.

Additionally, the modified Networked Device with the second technical emphasis NWDD_{TE2}, which is also preferably designed as a Computer, a Server, a Server farm, a Programmable Logic Controller (PLC), etc., includes the same components, entities and elements as the modified Networked Device with the first technical emphasis NWDD_{TE1}. For this reason it should be noted the difference to the modified Networked Device with the first technical emphasis NWDD_{TE1}.

The only differences are that on the “n” Virtual Machines VM1 . . . VMn are running no “Application's Software (App's)” and instead of this the “Application's Software (App's)” AS1 . . . ASn and the “Real Time-Application Software (App)” RT-AS are running directly on the Networked Device with the second technical emphasis NWDD_{TE2}.

Finally, the modified Network Device NWD, which is preferably designed as a Physical Switch, a Physical Router or a Physical Gateway include

A) a Forwarding Queue Assignment Entity FQAE including by assignment some Queuing-Elements QE serving as linkage between the Forwarding Queue Assignment Entity FQAE and a number of the Network Interface Cards NIC belonging to the Communication Interface COI,
B) the Scheduler SCD assigned to the Forwarding Queue Assignment Entity FQAE and the technical link TL_{NW/SNW},
C) the “End-to-End”-Synchronization Protocol E2E-SP assigned to the Scheduler SCD and
D) the clock CLK assigned to Scheduler SCD and the “End-to-End”-Synchronization Protocol E2E-SP.

It should be noted and reminded that the modified Network Device NWD could be realized as the Network Component, which again is one Virtual Machine of the at least one Virtual Machine VM1 . . . VMn, such as a Virtual Switch, a Virtual Router or a Virtual Gateway, hosted by the modified Networked Device NWDD, NWDD_{TE1}, NWDD_{TE2}. In this case the Network Component is part of the modified Networked Device and has not structural elements of the modified Network Device NWD.

Moreover the modified Networked Device with the first technical emphasis NWDD_{TE1} include the Software Agent SWA with the same structural elements as cited above [cf section “To 3):” ], which as the central control entity particularly with regard to the “Software Defined Networking” in the modified “Software Defined Networking (SDN)”-System SDNS is assigned to the Scheduler SCD, the “End-to-End”-Synchronization Protocol E2E-SP and the Forwarding Queue Assignment Entity FQAE.

The cooperation of the above-described system components of the modified “Software Defined Networking (SDN)”-System SDNS is based on the control channels CC via which the Communication Protocol COP is processed such that by interaction between the Functional Units FTU being formed by the Sensor SE, the Actor AC the Determining Means DM in the Software Agents SWA in the modified Networked Device NWDD, NWDD_{TE1}, NWDD_{TE2} and the modified Network Device NWD and the Processor PRC of the modified SDN-Controller SDNC involving the Path Finder Program Module PFPM, the Calculating/Scheduling Program Module CSPM, the Synchronization Program Module SYPM and the Remote Access and Configuration Program Module RACPM

I) a service list being embedded in the Communication Protocol COP and encapsulating modeled data of a flexible data model, which is involved into the Operating System OPS of the Networked Device NWDD, by translating bi-directionally between the command and the message of the Communication Protocol COP and the modeled data in order to enable
a remote access management of the at least one of the Networked Device NWDD, NWDD_{TE1}, NWDD_{TE2}, the networked device-hosted App RT-AS, AS1 . . . ASn and the networked device-hosted Virtual Machine RT-VM, VM1 . . . VMn in view of the networked device-specific capabilities, in particular including the Operating System OPS resources being offered and network functions or services being supported by the Networked Device NWDD, NWDD_{TE1}, NWDD_{TE2} and
a remote configuration functionality of the Networked Device NWDD, NWDD_{TE1}, NWDD_{TE2},
   is transmitted via the control channel CC for the protocol- and data model-based interaction between the Networked Device NWDD, NWDD_{TE1}, NWDD_{TE2}, the Network Device NWD and the SDN-Controller SDNC, which based on the Communication Interface COI is embedded into a Logical Management Interface LMI,
   II) the service list is evaluable with respect to the purpose of the “Software Defined Networking (SDN)” for controlling the handling of the routing or controlling decisions.

To address and achieve also within the cooperation of the above-described system components of the modified “Software Defined Networking (SDN)”-System SDNS “Real-Time-Capability”, which is realized “End-to-End” between the Networked Device NWDD and the SDN-Controller SDNC with respect to the controlling of the at least one Physical Machine of the technical domain, according to an

a) Option “A” the Software Agent SWA is acting with the Scheduler SCD being assigned to the Central Processing Unit CPU and the Memory MEM and thereby using the “End-to-End”-Synchronization Protocol E2E-SP being assigned to the Scheduler SCD to schedule accesses to the Central Processing Unit CPU and the Memory MEM and to guarantee the scheduled accesses to the Central Processing Unit CPU and the Memory MEM.
b) Option “B” the Software Agent SWA is acting within the Operating System OPS with a “Real-Time”-Core RTC of the Central Processing Unit CPU to allocate a share of the Central Processing Unit CPU and the Memory MEM and to guarantee the allocated share of the Central Processing Unit CPU and the Memory MEM.

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1. A Method for Software Defined Networking a cyber-physical Network of different technical domains, whereby
a) the Network includes:
a1) at least one Networked Device comprising an Operating System with a Central Processing Unit and a Memory, controlling at least one Physical Machine of the technical domain, functioning with respect to the Network as an end node and non-hosting or hosting at least one of at least one “Application Software” and at least one embedded Virtual Machine, and
a2) a number of Network Components, whereby the number of Network Components is at least equal to the number of the Networked Devices, the Network Component functions with respect to the Network as an intermediate node and the Network Components are at least partly assigned to the Networked Device such that:
a21) the Network Component is one Virtual Machine of the at least one embedded Virtual Machine, such as a Virtual Switch, a Virtual Router or a Virtual Gateway, or
a22) the Network Component is a Network Device within the Network, such as a Physical Switch, a Physical Router or a Physical Gateway, being connectable with the Networked Device and the Operating System with its system resources,
b) with respect to the purpose of the “Software Defined Networking”
b1) the handling of data packets and routing or controlling decisions within the Network are separated such that the data packet handling by the intermediate node and data packet transmitting by the end node, is done via data paths and the handling of routing or controlling decisions is done via control paths involving at least one of the Network Components and remotely controlled by at least one SDN-Controller using a Communication Protocol according to which at least one of PUSH/PULL-based commands and PUSH/PULL-based messages are sent and received,
b2) the Networked Device respectively the Network Device includes a Communication Interface via which:
b21) the Networked Device respectively the Network Device is connectable with the SDN-Controller and
b22) the Communication Protocol is processed,
wherein c) modifying the Networked Device or the Networked Device and the Network Device with respect to an extended “Software Defined Networking” based on extended control paths, which in comparison to the control paths are extended over an “End-to-End”-Communication within the cyber-physical Network between the Networked Device and the SDN-Controller, by implementing and involving a flexible data model modeling data into the Operating System of the Networked Device for enabling
c1) a remote access management of at least one of the Networked Device, the networked device-hosted App and the networked device-hosted Virtual Machine in view of the networked device-specific capabilities, in particular including the Operating System resources being offered and network functions or services being supported by the Networked Device, and
c2) a remote configuration functionality of the Networked Device;
d) deploying based on the Communication Interface a Logical Management Interface embedding a control channel for the protocol- and data model-based interaction between the Networked Device and the SDN-Controller; and
e) encapsulating the modeled data for enabling the remote access management of the at least one of the Networked device, the networked device-hosted App and the networked device-hosted Virtual Machine in view of the networked device-specific capabilities and the remote configuration into a service list by translating bi-directionally between the command and the message of the Communication Protocol and the modeled data;
f) communicating the service list being embedded in the Communication Protocol to the SDN-Controller for controlling the handling of the routing or controlling decisions.

2. The method according to claim 1, wherein
the handling of the routing or controlling decisions due to the communicated service list encompasses managing the system resources of the Operating System including a Central Processing Unit and a Memory in the Networked Device such that “Real-Time-Capability” is realized “End-to-End” between the Networked Device and the SDN-Controller with respect to the controlling of the at least one Physical Machine of the technical domain.

3. The method according to claim 2, wherein
the “Real-Time-Capability” is achieved by providing a Scheduler being assigned to the Central Processing Unit and the Memory and a “End-to-End”-Synchronization Protocol being assigned to the Scheduler to schedule accesses to the Central Processing Unit and the Memory and to guarantee the scheduled accesses to the Central Processing Unit and the Memory.

4. The method according to claim 2, wherein
the “Real-Time-Capability” is achieved by providing within the Operating System a “Real-Time”-Core in the Central Processing Unit to allocate a share of the Central Processing Unit and the Memory and to guarantee the allocated share of the Central Processing Unit and the Memory.

5. The method according claim 2, wherein
the handling of the routing or controlling decisions in the Network Device regarding the “Real-Time-Capability” is realized and achieved by providing a Scheduler being assigned to a Forwarding Queue Assignment Entity and a “End-to-End”-Synchronization Protocol being assigned to the Scheduler to queue Communication Protocol related data to be forwarded.

6. The method according to claim 1, wherein
at least one of the at least one “Application Software” is a “Real-Time”-App and/or at least one of the at least one embedded Virtual Machine is a “Real-Time”-Virtual Machine.

7. The method according to claim 1, wherein
at least one of the at least one “Application Software” is running on at least one of the at least one embedded Virtual Machine.

8. The method according to claim 1, wherein
the SDN-Controller is a physical controller platform such as server or server farm or virtual machine platform.

9. A Software Agent for Software Defined Networking a cyber-physical Network of different technical domains, in particular an industry automation network, whereby
a) the Network includes
a1) at least one Networked Device, such as a Computer, a Server, a Server farm, a Programmable Logic Controller, etc., comprising a Operating System with its system resources, such as Central Processing Unit, controlling at least one Physical Machine of the technical domain, functioning with respect to the Network as an end node and non-hosting or hosting at least one of at least one “Application Software” and at least one embedded Virtual Machine, and
a2) a number of Network Components, whereby the number of Network Components is at least equal to the number of the Networked Devices, the Network Component functions with respect to the Network as an intermediate node and the Network Components are at least partly assigned to the Networked Device such that
a21) the Network Component is one Virtual Machine of the at least one embedded Virtual Machine, such as a Virtual Switch, a Virtual Router or a Virtual Gateway, or
a22) the Network Component is a Network Device within the Network, such as a Physical Switch, a Physical Router or a Physical Gateway, being connectable with the Networked Device and the Operating System with its system resources,
b) with respect to the purpose of the “Software Defined Networking”
b1) the handling of data packets and routing or controlling decisions within the Network are separated such that the data packet handling, in particular data packet forwarding by the intermediate node and data packet transmitting by the end node, is done via data paths and the handling of routing or controlling decisions is done via control paths involving at least one of the Network Components and remotely controlled by at least one SDN-Controller using a Communication Protocol according to which at least one of PUSH/PULL-based commands and PUSH/PULL-based messages are sent and received,
b2) the Networked Device respectively the Network Device includes a Communication Interface via which
b21) the Networked Device respectively the Network Device is connectable with the SDN-Controller and
b22) the Communication Protocol is processed,
wherein c) being implementable into the Networked Device including the Operating System with its system resources and where applicable into the Network Device,
d) at least one Sensor perceiving an operating environment of the Software Agent defined by the Networked Device respectively the Network Device within the Network and regarding the SDN-purpose, at least one Actor interacting in that environment and Determining Means for determining how the Software Agent is going to interact with the environment, which are designed such and forming a Functional Unit referring to as an “agent function” that
d1) the Networked Device or the Networked Device and the Network Device with respect to an extended “Software Defined Networking” based on extended control paths, which in comparison to the control paths are extended over “End-to-End”-Communication within the cyber-physical Network between the Networked Device and the SDN-Controller, is respectively are modifiable by implementing and involving a flexible data model modeling data into the Operating System of the Networked Device for enabling
d11) a remote access management of at least one of the Networked Device, the networked device-hosted App and the networked device-hosted Virtual Machine in view of the networked device-specific capabilities, in particular including the Operating System resources being offered and network functions or services being supported by the Networked Device, and
d12) a remote configuration functionality of the Networked Device,
d2) based on the Communication Interface a Logical Management Interface embedding a control channel for the protocol- and data model-based interaction between the Networked Device and the SDN-Controller is deployed,
d3) the modeled data for enabling the remote access management of the at least one of the Networked Device, the networked device-hosted App and the networked device-hosted Virtual Machine in view of the networked device-specific capabilities and the remote configuration is encapsulated into a service list by translating bi-directionally between the command and the message of the Communication Protocol and the modeled data, and
d4) the service list being embedded in the Communication Protocol is communicable to the SDN-Controller for controlling the handling of the routing or controlling decisions.

10. The Software Agent according to claim 9, wherein
the Sensor, the Actor and the Determining Means are designed with respect to the handling of the routing or controlling decisions due to the communicated service list, which encompasses managing the system resources of the Operating System including a Central Processing Unit and a Memory in the Networked Device, such that “Real-Time-Capability” is realized “End-to-End” between the Networked Device and the SDN-Controller with respect to the controlling of the at least one Physical Machine of the technical domain.

11. The Software Agent according to claim 10, wherein
the Sensor, the Actor and the Determining Means are designed such that the “Real-Time-Capability” is achieved by acting with a Scheduler being assigned to the Central Processing Unit and the Memory and by using a “End-to-End”-Synchronization Protocol being assigned to the Scheduler to schedule accesses to the Central Processing Unit and the Memory and to guarantee the scheduled accesses to the Central Processing Unit and the Memory.

12. The Software Agent according to claim 10, wherein
the Sensor, the Actor and the Determining Means are designed such that the “Real-Time-Capability” is achieved by acting within the Operating System with a “Real-Time”-Core of the Central Processing Unit to allocate a share of the Central Processing Unit and the Memory and to guarantee the allocated share of the Central Processing Unit and the Memory.

13. The Software Agent according to claim 10, wherein
the Sensor, the Actor and the Determining Means are designed such that the handling of the routing or controlling decisions in the Network Device regarding the “Real-Time-Capability” is realized and achieved by acting with a Scheduler being assigned to a Forwarding Queue Assignment Entity and by using a “End-to-End”-Synchronization Protocol being assigned to the Scheduler to queue Communication Protocol related data to be forwarded.

14. The Software Agent according to claim 9, wherein
at least one of the at least one “Application Software” is a “Real-Time”-App and/or at least one of the at least one embedded Virtual Machine is a “Real-Time”-Virtual Machine.

15. The Software Agent according to claim 9, wherein
at least one of the at least one “Application Software” is running on at least one of the at least one embedded Virtual Machine.

16. The Software Agent according to claim 9, wherein
the SDN-Controller is a physical controller platform such as server or server farm or virtual machine platform.

17. A Networked Device, such as a Computer, a Server, a Server farm, a Programmable Logic Controller, etc., for Software Defined Networking a cyber-physical Network of different technical domains, in particular an industry automation network, which comprises a Operating System with its system resources, such as Central Processing Unit and a Memory, controls at least one Physical Machine of the technical domain, functions with respect to the Network as an end node, is non-hosting or hosting at least one of at least one “Application Software” and at least one embedded Virtual Machine and is one of at least one Networked device within the Network, whereby
a) the network includes
a1) a number of Network Components, whereby the number of Network Components is at least equal to the number of the Networked Devices, the Network Component functions with respect to the Network as an intermediate node and the Network Components are at least partly assigned to the Networked Device such that
a11) the Network Component is one Virtual Machine of the at least one embedded Virtual Machine, such as a Virtual Switch, a Virtual Router or a Virtual Gateway, or
a12) the Network Component is a Network Device within the Network, such as a Physical Switch, a Physical Router or a Physical Gateway, being connectable with the Networked Device and the Operating System with its system resources,
b) with respect to the purpose of the “Software Defined Networking”
b1) the handling of data packets and routing or controlling decisions within the Network are separated such that the data packet handling, in particular data packet forwarding by the intermediate node and data packet transmitting by the end node, is done via data paths and the handling of routing or controlling decisions is done via control paths involving at least one of the Network Components and remotely controlled by at least one SDN-Controller using a Communication Protocol according to which at least one of PUSH/PULL-based commands and PUSH/PULL-based messages are sent and received,
b2) the Networked Device respectively the Network Device includes a Communication Interface via which
b21) the Networked Device respectively the Network Device is connectable with the SDN-Controller and
b22) the Communication Protocol is processed,
c) a Software Agent, which includes at least one Sensor perceiving an operating environment of the Software Agent defined by the Networked Device within the Network and regarding the SDN-purpose, at least one Actor interacting in that environment and Determining Means for determining how the Software Agent is going to interact with the environment and which is assigned to the Operating System with its system resources such that
c1) the Networked Device (NW with respect to an extended “Software Defined Networking” based on extended control paths, which in comparison to the control paths are extended over “End-to-End”-Communication within the cyber-physical Network between the Networked Device and the SDN-Controller, is modifiable by implementing and involving a flexible data model modeling data into the Operating System of the Networked Device for enabling
c11) a remote access management of at least one of the Networked Device, the networked device-hosted App and the networked device-hosted Virtual Machine in view of the networked device-specific capabilities, in particular including the Operating System resources being offered and network functions or services being supported by the Networked Device, and
c12) a remote configuration functionality of the Networked Device,
c2) based on the Communication Interface a Logical Management Interface embedding a control channel for the protocol- and data model-based interaction between the Networked Device and the SDN-Controller is deployed,
c3) the modeled data for enabling the remote access management of the at least one of the Networked Device, the networked device-hosted App and the networked device-hosted Virtual Machine in view of the networked device-specific capabilities and the remote configuration is encapsulated into a service list by translating bi-directionally between the command and the message of the Communication Protocol and the modeled data, and
c4) the service list being embedded in the Communication Protocol is communicable to the SDN-Controller for controlling the handling of the routing or controlling decisions.

18. The Networked Device according to claim 17, wherein
the Software Agent is designed with respect to the handling of the routing or controlling decisions due to the communicated service list, which encompasses managing the system resources of the Operating System including a Central Processing Unit and a Memory, such that “Real-Time-Capability” is realized “End-to-End” between the Networked Device and the SDN-Controller with respect to the controlling of the at least one Physical Machine of the technical domain.

19. The Networked Device according to claim 18, wherein
the Software Agent is designed such that “Real-Time-Capability” is achieved by acting with a Scheduler being assigned to the Central Processing Unit and the Memory and by using a “End-to-End”-Synchronization Protocol being assigned to the Scheduler to schedule accesses to the Central Processing Unit and the Memory and to guarantee the scheduled accesses to the Central Processing Unit and the Memory.

20. The Networked Device according to claim 18, wherein
the Software Agent is designed such that “Real-Time-Capability” is achieved by acting within the Operating System with a “Real-Time”-Core of the Central Processing Unit to allocate a share of the Central Processing Unit and the Memory and to guarantee the allocated share of the Central Processing Unit and the Memory.

21. The Networked Device according to claim 17, wherein
at least one of the at least one “Application Software” is a “Real-Time”-App and/or at least one of the at least one embedded Virtual Machine is a “Real-Time”-Virtual Machine.

22. The Networked Device according to claim 17, wherein
at least one of the at least one “Application Software” is running on at least one of the at least one embedded Virtual Machine.

23. The Networked Device according to claim 17, wherein
the SDN-Controller is a physical controller platform such as server or server farm or virtual machine platform.

24. A SDN-Controller for Software Defined Networking a cyber-physical Network of different technical domains, in particular an industry automation network, which comprises a non-transitory processor readable Storage Device having processor-readable program-instructions stored therein, the processor-readable program-instructions being executable by a Processor to handle data packets and to route or control decisions within the Network by involving a Path Finder Program Module, a Calculating/Scheduling Program Module, a Synchronization Program Module and a Remote Access and Configuration Program Module, whereby
a) the Network includes
a1) at least one Networked Device, such as a Computer, a Server, a Server farm, a Programmable Logic Controller, etc., comprising a Operating System with its system resources, such as Central Processing Unit and a Memory controlling at least one Physical Machine of the technical domain, functioning with respect to the Network as an end node and non-hosting or hosting at least one of at least one “Application Software” and at least one embedded Virtual Machine, and
a2) a number of Network Components, whereby the number of Network Components is at least equal to the number of the Networked Devices, the Network Component functions with respect to the Network as an intermediate node and the Network Components are at least partly assigned to the Networked Device such that
a21) the Network Component is one Virtual Machine of the at least one embedded Virtual Machine, such as a Virtual Switch, a Virtual Router or a Virtual Gateway, or
a22) the Network Component is a Network Device within the Network, such as a Physical Switch, a Physical Router or a Physical Gateway, being connectable with the Networked Device and the Operating System with its system resources,
b) with respect to the purpose of the “Software Defined Networking”
b1) the handling of data packets and routing or controlling decisions within the Network are separated such that the data packet handling, in particular data packet forwarding by the intermediate node and data packet transmitting by the end node, is done via data paths and the handling of routing or controlling decisions is done via control paths (involving at least one of the Network Components and remotely controlled by at least one SDN-Controller using a Communication Protocol according to which at least one of PUSH/PULL-based commands and PUSH/PULL-based messages are sent and received,
b2) the Networked Device respectively the Network Device includes a Communication Interface via which
b21) the Networked Device respectively the Network Device is connectable with the SDN-Controller and
b22) the Communication Protocol is processed,
wherein
c) the Processor involving the Path Finder Program Module, the Calculating/Scheduling Program Module, the Synchronization Program Module and the Remote Access and Configuration Program Module is designed such and processed the Communication Protocol with respect to an extended “Software Defined Networking” based on extended control paths, which in comparison to the control paths are extended over an “End-to-End”-Communication within the cyber-physical Network between the Networked Device and the SDN-Controller such that
a service list being embedded in the Communication Protocol and encapsulating modeled data of a flexible data model, which is involved into the Operating System of the Networked Device, by translating bi-directionally between the command and the message of the Communication Protocol and the modeled data in order to enable
a remote access management of the at least one of the Networked device, the networked device-hosted App and the networked device-hosted Virtual Machine in view of the networked device-specific capabilities, in particular including the Operating System resources being offered and network functions or services being supported by the Networked Device and
a remote configuration functionality of the Networked Device,
is receivable via a control channel for the protocol- and data model-based interaction between the Networked Device or the Networked Device and the Network Device and the Processor, which based on the Communication Interface is embedded into a Logical Management Interface,
the service list is evaluable for controlling the handling of the routing or controlling decisions.

25. The Cyber-Physical Network of different technical domains, in particular an industry automation network, for Software Defined Networking,
wherein
a) at least one Networked Device according to claim 17 and a number of Network Components including each a Software Agent according to one of the claim 9
b) at least one SDN-Controller according to claim 24 carrying out each the method according to claim 1.
